(19) United States
(12) Patent Application Publication
(10) Pub. No.: US 2021/0167454 A1
(43) Pub. Date: Jun. 3, 2021

(54) Battery Pack and Propulsion Device

(71) Applicant: Yanmar Power Technology Co., Ltd., Osaka (JP)

(72) Inventors: Hideaki Aoki, Osaka (JP); Taro Okamatsu, Osaka (JP)

(73) Assignee: Yanmar Power Technology Co., Ltd., Osaka (JP)

(21) Appl. No.: 17/048,522

(22) PCT Filed: Apr. 12, 2019
(86) PCT No.: PCT/JP2019/015891

§ 371 Date: Oct. 16, 2020

(30) Foreign Application Priority Data
Apr. 18, 2018 (JP) 2018-080264

(51) Int. Cl. H01M 50/213; H01M 50/249

(52) U.S. Cl. CPC H01M 50/213; H01M 2220/20; H01M 50/249

(57) ABSTRACT

A battery pack includes a plurality of tubular batteries, holders, a storage bag, and a battery casing. The holders hold the plurality of tubular batteries. The storage bag is a flexible bag-shaped member in the interior of which the holders holding the plurality of tubular batteries are accommodated, and is filled with an insulating filler that is fluid and not solidified during use. The battery casing accommodates the storage bag in which the holders are accommodated.

### TECHNICAL FIELD

The present invention mainly relates to a battery pack which includes holders that hold a plurality of tubular batteries.

### BACKGROUND ART

Conventionally, as disclosed in Patent Literature 1, a battery pack is known which includes a holder made of a thermoplastic resin that holds a plurality of batteries. The battery pack of Patent Literature 1 includes a holder that holds the batteries, and a waterproof bag that accommodates the holder. A potting resin is injected into the waterproof bag. Because the potting resin adheres to the surface of the batteries and the battery holder, the heat of the batteries can be efficiently released.

### CITATION LIST

### Patent Literature

Patent Literature 1: JP 6242799 B2

### DISCLOSURE OF INVENTION

### Problems to be Solved by the Invention

However, even though the potting resin is a paste or liquid form at the time of injection, it hardens after injection and loses its fluidity. Therefore, when a gas is generated from the batteries, the gas cannot be released, and it is difficult to suppress the increase in pressure due to this gas.

The present invention has been made in view of the above circumstances, and a primary object thereof is to provide a battery pack that, when a gas is generated from the batteries, is capable of suppressing the increase in pressure due to the gas.

### Means for Solving the Problems

The problem to be solved by the present invention is as described above, and the means for solving the problem and the effect thereof will be described below.

According to a first aspect of the present invention, a battery pack having the following configuration is provided. That is to say, the battery pack includes a plurality of batteries, a plurality of holders, a storage bag, and a battery casing. The holders hold the plurality of batteries. The storage bag is a flexible bag-shaped member in the interior of which the holders holding the plurality of batteries are accommodated, and is filled with an insulating filler that is fluid and not solidified during use. The battery casing accommodates the storage bag in which the holders are accommodated.

As a result of the insulating fluid being a fluid, even when a gas is generated from the batteries, the gas can be moved through the insulating filler to reduce the pressure. Furthermore, because the insulating filler also enters between the batteries and the holders, the heat transfer between tubular batteries is promoted due to the increased adhesion between the batteries and the insulating filler. As a result, the temperature of the plurality of tubular batteries can be made more uniform. Moreover, as a result of the insulating filler being filled in a flexible bag-shaped member, it becomes easier to align the storage bag with the shape of the holders and the like, and therefore, it becomes possible to reduce the size of the battery pack, and to reduce the weight by reducing the amount of the insulating filler.

In the battery pack described above, it is preferable to include a discharge part that opens when a gas is generated from the batteries, and at least discharges the gas to the outside of the battery casing.

Consequently, even when a gas is generated from the batteries, it is possible to discharge the gas to the outside of the battery casing via the discharge part.

The battery pack mentioned above preferably has the following configuration. That is to say, the battery casing includes a case body and a lid portion. The case body has a cylindrical shape and has at least one end which is open. The lid portion closes the portion of the case body which is open. The space filled by the insulating filler is closed by the lid portion, and the discharge part is formed in the lid portion.

Consequently, the gas generated from the batteries can be discharged to the outside of the battery casing via the discharge part in the lid portion. Furthermore, compared to a case where discharge parts are individually provided in the storage bag and the battery casing, the structure for discharging the gas can be simplified.

The battery pack mentioned above preferably has the following configuration. That is to say, the battery pack includes a battery control unit that determines a state of the plurality of batteries based on a detection result of a sensor. The battery control unit is accommodated in the storage bag.

As a result, the battery control unit is waterproofed by the storage bag. Furthermore, when a harness is connected to the battery control unit, the harness is also waterproofed by the storage bag.

According to a second aspect of the present invention, a propulsion device having the following configuration is provided. That is to say, the propulsion device includes the battery pack described above, a drive source, and a propulsion unit. The drive source is driven by electric power supplied from the battery pack. The propulsion unit uses a drive force generated by the drive source to generate a propulsive force that moves a moving body.

Consequently, it is possible to realize a propulsion device having a configuration in which the temperature of a plurality of tubular batteries is made uniform, even in a wide operating temperature environment.

### BRIEF DESCRIPTION OF DRAWINGS

FIG. 1 is a perspective view showing a configuration of an electric sliding body provided with a propulsion device according to a first embodiment of the present invention.

FIG. 2 is a cross-sectional view of a battery pack cut along a plane parallel to the axial direction.

FIG. 3 is a cross-sectional perspective view of the battery pack.

FIG. 4 is a perspective view showing the shape of the holders.

FIG. 5 is a side view of an all-terrain vehicle provided with a propulsion device according to a second embodiment.

### DESCRIPTION OF EMBODIMENTS

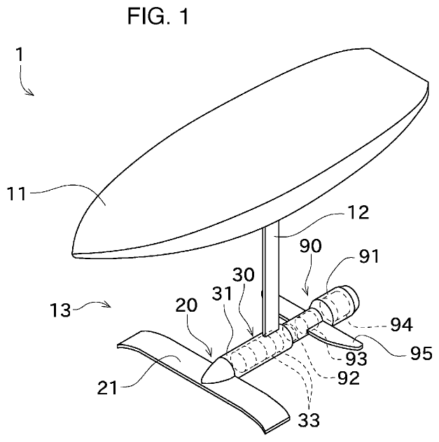

Next, a first embodiment of the present invention will be described with reference to the drawings. FIG. 1 is a perspective view showing a configuration of an electric sliding body 1 provided with a propulsion device 13 according to the first embodiment. Furthermore, in the description below, front, rear, left, and right are defined assuming that the forward direction of the electric sliding body 1 is the front. The electric sliding body 1 shown in FIG. 1 is a vehicle that slides on water by acquiring a thrust generated by electric power. As shown in FIG. 1, the electric sliding body 1 includes a surfboard 11, a support column 12, and a propulsion device 13.

The surfboard 11 is a plate-shaped member having a flat upper surface. The surfboard 11 slides on water as a result of the propulsion device 13 generating a propulsive force while a person is on the upper surface of the surfboard 11. In addition, another member that travels on water or underwater may be provided instead of the surfboard 11. Furthermore, a support column 12 is connected to the lower surface of the surfboard 11. The support column 12 downwardly extends from the lower surface of the surfboard 11, and is connected to the upper surface of the propulsion device 13.

The propulsion device 13 generates a propulsive force for propelling the surfboard 11. The propulsion device 13 includes a head unit 20, a battery pack 30, and a propulsive force generation unit 90.

The head unit 20 is a member that configures the front part of the propulsion device 13. The head unit 20 has a shape in which the outer diameter decreases toward the front. A front foil 21 is connected to the head unit 20. The front foil 21 is arranged so as to extend in the left-right direction from the head unit 20. At the time of propulsion, the front foil 21 causes the electric sliding body 1 to generate a levitation force, and stabilizes the behavior of the electric sliding body 1.

The battery pack 30 is a part that stores electric power used to generate a propulsive force. The battery pack 30 is detachably attached to the rear of the head unit 20. The battery pack 30 includes a plurality of tubular batteries 34. Further, the battery pack 30 is configured to be capable of transmitting electric power to the propulsive force generation unit 90. Moreover, the battery pack 30 is configured so that the state of the tubular batteries 34 can be determined based on the voltage values of the tubular batteries 34, the surrounding temperature, and the like. The detailed configuration of the battery pack 30 will be described later.

The propulsive force generation unit 90 is detachably attached to the rear of the battery pack 30. In this manner, the battery pack 30 of the present embodiment is configured to be separable from both the head unit 20 and the propulsive force generation unit 90. The propulsive force generation unit 90 includes a drive casing 91, an inverter 92, an electric motor (drive source) 93, a screw (propulsion unit) 94, and a rear foil 95.

The inverter 92, the electric motor 93, and the screw 94 are arranged inside the drive casing 91. The direct current supplied from the battery pack 30 is converted into an alternating current having a predetermined frequency by the inverter 92, and supplied to the electric motor 93. The electric motor 93 generates a drive force from the alternating current supplied from the inverter 92, and rotates the screw 94. The propulsive force generation unit 90 generates a propulsive force as a result of the above configuration. Furthermore, like the front foil 21, the rear foil 95 causes the electric sliding body 1 to generate a levitation force, and stabilizes the behavior of the electric sliding body 1.

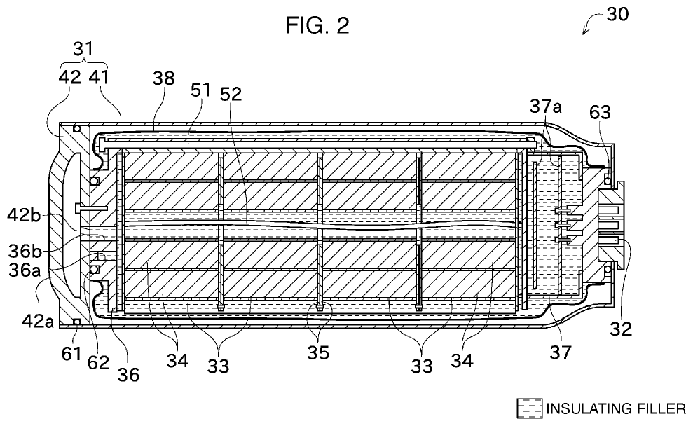

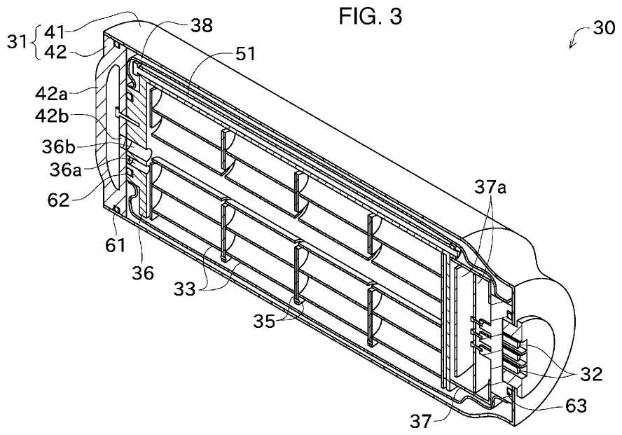

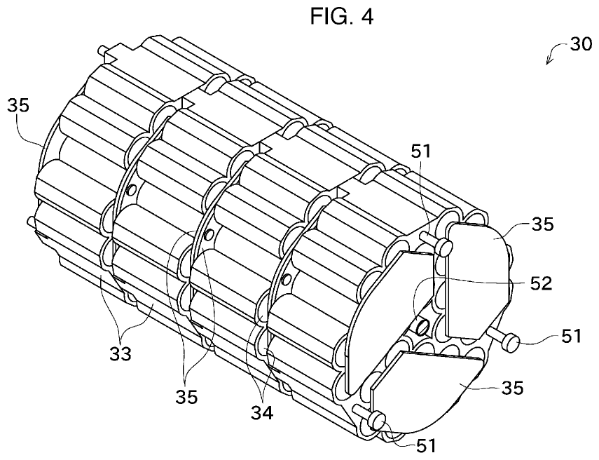

Next, the configuration of the battery pack 30 will be described with reference to FIG. 2 to FIG. 4. FIG. 2 is a cross-sectional view of the battery pack 30 cut along a plane parallel to the axial direction. FIG. 3 is a cross-sectional perspective view of the battery pack 30. FIG. 4 is a perspective view showing the shape of the holders 33. Note that, in the description below, the axial direction of the battery casing 31 or the tubular batteries 34 or the like may be simply referred to as the “axial direction”. Furthermore, the direction perpendicular to the axial direction is sometimes referred to as the “radial direction”.

As shown in FIG. 2, the battery pack 30 includes a battery casing 31, an external terminal 32, holders 33, tubular batteries 34, conductive plates 35, a closed part 36, a board housing unit 37, and a storage bag 38. Moreover, the inside of the storage bag 38 is filled with an insulating filler (the details will be described later).

The battery casing 31 is a member for accommodating each of the parts constituting the battery pack 30. The battery casing 31 includes a case body 41 and a lid portion 42. The case body 41 has a cylindrical shape and has one axial direction end (on the head unit 20 side) which is open. The lid portion 42 is arranged inside the case body 41 in the radial direction so as to close the opening of the case body 41. Furthermore, a first seal member 61 is arranged between the case body 41 and the lid portion 42. The first seal member 61 is an O-ring or the like, and prevents the entry of water into the case body 41 from between the case body 41 and the lid portion 42. Further, even if a tear occurs in the storage bag 38, it is possible to prevent the insulating filler from flowing out to the outside of the battery casing 31. The other axial direction end of the case body 41 is also open, and is closed by an external terminal 32 and a member or the like which holds the external terminal 32. However, the case body 41 may have a configuration in which only one axial direction end is open.

In addition, the lid portion 42 is provided with a handle 42a and a discharge valve (discharge part) 42b. The handle 42a is provided on the outside of the lid portion 42 in the axial direction. The handle 42a is a rod-shaped member that the user can hold by hand. Furthermore, as mentioned above, because the battery pack 30 is separable from the head unit 20 and the propulsive force generation unit 90, the user is able to easily hold and carry the battery pack 30 after separation by using the handle 42a. The discharge valve 42b is configured to open and allow a gas to pass through when a certain pressure level or higher is applied. The discharge valve 42b, for example, is configured to irreversibly open by creation of a tear or the like when the pressure difference exceeds a threshold value. Note that, because the function of the battery pack 30 is stopped when a large amount of gas is generated from the tubular batteries 34, the discharge valve 42b of the present embodiment has a configuration that irreversibly opens. However, the discharge valve 42b may use a valve having a configuration that opens when the pressure difference exceeds a threshold value, and closes again when the pressure difference becomes less than or equal to the threshold value. The discharge valve 42b is used to discharge the gas generated from the tubular batteries 34 to the outside of the battery pack 30 (the details will be described later).

The battery casing 31 is formed in a substantially cylindrical shape. The battery casing 31 of the present invention has a shape in which the length in the axial direction is shorter than the length in the radial direction (that is to say, a long and narrow shape). As a result of the battery casing 31 having such a cylindrical shape, the water pressure applied to the battery casing 31 becomes uniform, and therefore, a high-pressure resistance can be realized with a simple structure.

Furthermore, the battery casing 31 of the present embodiment constitutes the outer wall of the propulsion device 13, and also constitutes the casing of the battery pack 30. In other words, the battery casing 31 has both a function for protecting the inside from the external environment, such as water, and a function for accommodating and arranging the tubular batteries 34 and the like. Therefore, the space can be efficiently utilized compared to a configuration that includes two casings.

Moreover, the battery casing 31 of the present embodiment is not produced by joining two semi-cylindrical members, but is molded into a cylindrical shape from the beginning. Therefore, no joint marks or the like are formed on the outer peripheral surface of the battery casing 31. Consequently, it is possible to prevent the entry of water from the outer peripheral surface with a simple configuration, without performing steps such as providing a sealing material on the joint portions. Furthermore, in the present embodiment, the battery pack 30 is produced by assembling the members to be placed inside the battery casing 31 in advance, and then inserting the assembly into the battery casing 31.

The battery casing 31 may have a shape other than a cylindrical shape. Furthermore, the casing of the propulsion device 13 and the casing of the battery pack 30 may be separate members. Moreover, a configuration is possible in which the battery casing 31 is produced by joining a plurality of members.

The external terminal 32 is provided so as to project outward from the case body 41 on one axial direction side of the battery casing 31 (the propulsive force generation unit 90 side). The external terminal 32 can be connected to a charging terminal of a charging device, and a power supply terminal of the propulsive force generation unit 90. The tubular batteries 34 can be charged by connecting the external terminal 32 to the charging terminal. Electric power can be supplied to the propulsive force generation unit 90 by connecting the external terminal 32 to the power supply terminal. Therefore, the battery pack 30 is provided with an insertion sensor (identifying means) for identifying, with respect to the external terminal 32, whether the charging terminal or the power supply terminal is inserted into the external terminal 32.

It is also possible to identify which terminal is connected without using an insertion sensor by, for example, the battery pack 30 communicating with the charging device or propulsive force generation unit 90 side. Furthermore, the external terminal 32 can be used for both charging the tubular batteries 34 and supplying power to the propulsive force generation unit 90. Alternatively, the terminal for charging the tubular batteries 34 and the terminal for supplying power to the propulsive force generation unit 90 may be separate terminals.

As shown in FIG. 2 and FIG. 4, a plurality of tubular batteries 34 are held by the holders 33. The tubular batteries 34 are, for example, lithium ion batteries, and have a structure in which a positive electrode, a separator, a negative electrode, and the like are arranged inside a cylindrical outer can. The tubular batteries 34 are not limited to a cylindrical shape, and may have a tubular shape having a polygonal cross section. Further, the tubular batteries 34 may have a shape other than a tubular shape (for example, a cuboid shape). As a result of being held by the holders 33, the orientations of the plurality of tubular batteries 34 are aligned in the axial direction, and they are also arranged side by side in the radial direction.

As shown in FIG. 2 and FIG. 4, a plurality of holders 33 (four in this embodiment) is arranged side by side in the axial direction. The holders 33 are made of a material containing a flame-retardant resin as a main component. The holders 33 are formed with a plurality of tubular holding portions for inserting and holding the tubular batteries 34. Therefore, in the present embodiment, the tubular batteries 34 are individually held. The holders 33 may be configured to hold a plurality of tubular batteries 34 in a bundle (that is to say, in a manner that causes the tubular batteries 34 to be in contact with each other).

The conductive plates 35 are plate-shaped members made of metal and having conductivity. A plurality of conductive plates 35 are arranged side by side in the radial direction at one axial direction end of a holder 33, and a plurality of conductive plates 35 are also arranged side by side in the radial direction at the other axial direction end of the holder 33. The terminals of the plurality of tubular batteries 34 are each connected to the conductive plates 35 by a method such as spot welding or ultrasonic welding. As a result, the conductive plates 35 connect in parallel a plurality of the tubular batteries 34 arranged side by side in the radial direction.

Furthermore, as described above, the conductive plates 35 are respectively arranged at both ends of the holders 33 in the axial direction. Therefore, two conductive plates 35 are adjacent to each other in the axial direction except at the axial direction ends. These two conductive plates 35 are connected to each other by a method such as spot welding or ultrasonic welding. As a result, the conductive plates 35 connect in series the tubular batteries 34 arranged in mutually adjacent holders 33.

As shown in FIG. 2, the closed part 36 is arranged at the end portion on one side of the holders 33 (the head unit 20 side), which are arranged side by side in the axial direction. The closed part 36 closes one axial direction end of the holders 33. Bolt insertion holes are formed in both the closed part 36 and the holders 33. The closed part 36 and the holders 33 are joined by joining bolts 51. Furthermore, the closed part 36 is also joined with the lid portion 42 by a separate bolt.

Furthermore, an injection hole 36a and a passage hole 36b are formed in the closed part 36. The injection hole 36a is a hole for injecting the insulating filler into the storage bag 38. The passage hole 36b is a hole for allowing the gas generated by the tubular batteries 34 to pass through. The passage hole 36b is formed in a position facing the discharge valve 42b. The closed part 36 is configured so that the insulating filler inside does not flow out from parts other than the injection hole 36a and the passage hole 36b. That is to say, a second seal member 62 is arranged between the closed part 36 and the lid portion 42. The second seal member 62 is an O-ring or the like, and seals between the closed part 36 and the lid portion 42. As a result, the insulating filler does not flow out from between the closed part 36 and the lid portion 42.

With respect to the holders 33 arranged side by side in the axial direction, the board housing unit 37 is arranged at the end portion on the opposite side to the closed part 36. The board housing unit 37 is configured so that the insulating filler inside is not discharged to the outside. Furthermore, a third seal member 63 is arranged between the board housing unit 37 and the case body 41. The third seal member 63 is an O-ring or the like, and seals between the board housing unit 37 and the case body 41. As a result, it is possible to prevent water from entering into the battery casing 31 from between the battery casing 31 and the board housing unit 37. Further, even if a tear occurs in the storage bag 38, it is possible to prevent the insulating filler from flowing out to the outside of the battery casing 31.

A battery control board (battery control unit) 37a is arranged in the board housing unit 37. The battery control board 37a performs processing for realizing a BMS (battery management system). Specifically, the tubular batteries 34 are equipped with a sensor that detects a voltage value and a temperature. The battery control board 37a acquires the detection results of the voltage sensor and the temperature sensor via a harness 52. The harness 52 is connected to the battery control board 37a through, for example, a through hole formed in the holders 33. Based on the detection results, the battery control board 37a performs a control that prevents overcharging when charging the tubular batteries 34, and prevents overdischarging when power is supplied from the tubular batteries 34 to the propulsive force generation unit 90. The battery control board 37a may be configured to acquire the voltages and temperatures mentioned above in a wireless fashion rather than via the harness 52.

The storage bag 38 is a bag made of a material which is flexible, and does not allow the insulating filler filled inside to pass through. The holders 33 and the tubular batteries 34 are accommodated in the storage bag 38. The storage bag 38 of the present embodiment has a cylindrical shape, with one end welded to the outer surface of the closed part 36, and the other end welded to the outer surface of the board housing unit 37.

As a result, the battery control board 37a is accommodated in the storage bag 38 in addition to the holders 33 and the tubular batteries 34. The inside of the storage bag 38 has a waterproof structure so that the insulating filler does not flow out. Consequently, the holders 33, the tubular batteries 34, the battery control board 37a, the harness 52 connected to these components, and the like, are also waterproofed with respect to outside water. Therefore, by covering many members with the storage bag 38, it is possible to reduce the number of locations in which a waterproof structure is provided.

As mentioned above, the closed part 36 and the board housing unit 37 are configured so that the insulating filler filled inside is not discharged to the outside. In this manner, the closed part 36, the board housing unit 37, and the storage bag 38 form a space in which the holders 33 and the tubular batteries 34 are sealed. Therefore, the space in which the holders 33 and the tubular batteries 34 are arranged can be filled with the insulating filler.

Here, because the insulating filler does not have conductivity, unnecessary parts are not energized. Furthermore, because the insulating filler transfers heat more readily than air, even when only some of the tubular batteries 34 generate heat, the heat is easily released to the surroundings. As a result, the temperature of the plurality of tubular batteries 34 is made even more uniform. Moreover, because the insulating filler is fluid, it enters the gaps between the holders 33 and the tubular batteries 34. Therefore, it sufficiently adheres to the tubular batteries 34. As a result, heat dissipation of the tubular batteries 34 can be further promoted.

Further, because the holders 33 and the tubular batteries 34 are protected by both the storage bag 38 (and the insulating filler inside) and the battery casing 31, a battery pack 30 having excellent impact resistance can be realized.

Also, the insulating filler of the present embodiment is a liquid or gel-like substance that does not solidify after filling (in other words, has a non-solidifying property). The insulating filler is, for example, a silicon-based liquid. Therefore, the insulating filler is fluid even when the battery pack 30 is used. Consequently, even when a gas is generated from the holders 33, because the gas can be moved through the insulating filler, a local increase in the pressure can be avoided.

Specifically, when a gas is generated from the tubular batteries 34, the gas flows to the surroundings through the insulating filler. Here, since the conductive plates 35 are arranged between the holders 33, the holders 33 are arranged with a spacing. Therefore, irrespective of which tubular batteries 34 generate the gas, the gas does not fill a specific holder 33, and the overall pressure inside the holders 33 is uniformly increased. As mentioned above, the passage hole 36b is formed in the closed part 36, and the discharge valve 42b is provided at the end of the passage hole 36b.

With this configuration, if a gas is generated from the tubular batteries 34 and the pressure near the discharge valve 42b exceeds a predetermined value, the discharge valve 42b opens. As a result, the insulating filler is discharged from the discharge valve 42b, and the gas is also discharged from the discharge valve 42b. Consequently, prior to the inside of the battery pack 30 reaching a high pressure due to the gas generated from the tubular batteries 34, it is possible to discharge the gas to the outside of the battery pack 30 to reduce the pressure.

In the present embodiment, although the discharge valve (discharge part) 42b is provided in the lid portion 42, a discharge part may be provided in the closed part 36. Alternatively, a discharge part may be provided in the storage bag 38. However, if a discharge part is provided in the storage bag 38, a separate discharge part for discharging the gas discharged from the storage bag 38 to the outside of the battery pack 30 is required.

Next, a method of filling the insulating filler will be briefly described. Firstly, the holders 33 in which the tubular batteries 34 are arranged, the closed part 36, and the board housing unit 37 are joined. Then, the joined members are covered with the cylindrical storage bag 38. Next, one end of the storage bag 38 is welded to the outer surface of the closed part 36, and the other end of the storage bag 38 is welded to the outer surface of the board housing unit 37. Then, after suction of the air inside the storage bag 38 with a pump or the like, the insulating filler is injected from the injection hole 36a. The injection hole 36a is closed after the insulating filler is sufficiently filled. The insulating filler is filled as a result of the above.

In the present embodiment, the storage bag 38 has a cylindrical shape, and the two openings are each welded to another member. The storage bag 38 may instead have one opening. Furthermore, instead of welding the storage bag 38 to other members, a process of closing the openings of the storage bag 38 may be performed. Furthermore, the storage bag 38 may be configured to not accommodate the board housing unit 37.

Hereinafter, the present embodiment will be compared with a configuration in which the insulating filler is filled in a non-flexible storage component rather than the storage bag 38. Because it is difficult or more costly to prepare such storage components with a shape that aligns with the holders 33 and the like, they have a relatively simple shape such as a cylindrical shape. Therefore, unnecessary gaps are formed between the storage component and the holders 33. As a result, the size of the battery pack 30 increases, and the weight increases due to the increased amount of the insulating filler. In addition, the waterproof structure in such storage components for preventing the insulating filler from flowing out can become complicated.

In this regard, in the present embodiment, the flexible storage bag 38 is filled with an insulating filler. Therefore, the use of a storage bag 38 having an appropriate size enables the storage bag 38 to be aligned with the shape of the holders 33 or the like. As a result, the size of the battery pack 30 can be reduced, and the weight can be reduced by reducing the amount of the insulating filler. Further, because the inside of the storage bag 38 can be sealed by welding to other parts (specifically, the closed part 36 and the board housing unit 37), the waterproof structure can be simplified.

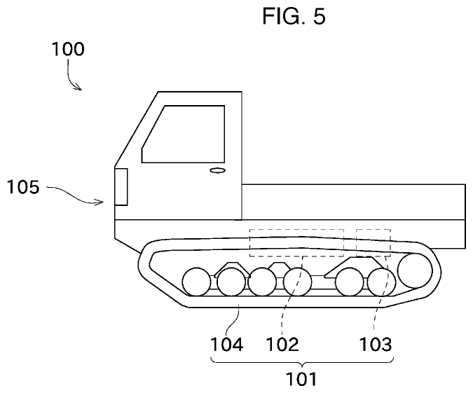

Next, a second embodiment will be described. FIG. 5 is a side view of an all-terrain vehicle 100 provided with a propulsion device 101 according to the second embodiment.

The all-terrain vehicle 100 is a vehicle primarily for traveling on unpaved roads. The all-terrain vehicle 100 includes a propulsion device 101 and a vehicle body 105. The propulsion device 101 includes a battery pack 102, a hydraulic pump (drive source) 103, and a crawler (propulsion unit) 104.

The battery pack 102 of the second embodiment has the same configuration as in the first embodiment. The hydraulic pump 103 delivers hydraulic oil when electric power is supplied from the battery pack 102. The crawler 104 moves the battery pack 102 by being driven by the hydraulic oil delivered by the hydraulic pump 103. The crawler 104 may be driven by an electric motor rather than the hydraulic pump 103.

As described above, the battery packs 30 and 102 of the embodiments above include a plurality of tubular batteries 34, holders 33, a storage bag 38, and a battery casing 31. The holders 33 hold a plurality of tubular batteries 34. The storage bag 38 is a flexible bag-shaped member in the interior of which the holders 33 holding the plurality of tubular batteries 34 are accommodated, and is filled with an insulating filler that is fluid and not solidified during use. The battery casing 31 accommodates the storage bag 38 in which the holders 33 are accommodated.

As a result of the insulating fluid being a fluid, even when a gas is generated from the tubular batteries 34, the gas can be moved through the insulating filler to reduce the pressure. Furthermore, because the insulating filler also enters between the tubular batteries 34 and the holders 33, the heat transfer between tubular batteries 34 is promoted due to the increased adhesion between the tubular batteries 34 and the insulating filler. As a result, the temperature of the plurality of tubular batteries 34 can be made more uniform. Moreover, as a result of the insulating filler being filled in a flexible bag-shaped member, it becomes easier to align the storage bag 38 with the shape of the holders 33 and the like, and therefore, it becomes possible to reduce the size of the battery packs 30 and 102, and to reduce the weight by reducing the amount of the insulating filler.

In the battery packs 30 and 102 of the embodiments above, a discharge valve 42b is included that opens when a gas is generated from the tubular batteries 34, and at least discharges the gas to the outside of the battery casing 31.

Consequently, even when a gas is generated from the tubular batteries 34, it is possible to discharge the gas to the outside of the battery casing 31 via the discharge valve 42b.

Furthermore, the battery packs 30 and 102 of the embodiments above include a battery casing 31, a case body 41, and a lid portion 42. The case body 41 has a cylindrical shape and has at least one end which is open. The lid portion 42 closes the portion of the case body 41 which is open. The space filled by the insulating filler is closed by the lid portion 42, and the discharge valve 42b is formed in the lid portion 42.

Consequently, the gas generated from the tubular batteries 34 can be discharged to the outside of the battery casing 31 via the discharge valve 42b in the lid portion. Furthermore, compared to a case where discharge valves 42b are individually provided in the storage bag 38 and the battery casing 31, the structure for discharging the gas can be simplified.

Moreover, the battery packs 30 and 102 of the embodiments above include a battery control board 37a that determines a state of the plurality of tubular batteries 34 based on a detection result of a sensor. The battery control board 37a is accommodated in the storage bag 38.

As a result, in addition to the battery control board 37a, a harness 52 between the tubular batteries 34 and the battery control board 37a is also waterproofed by the storage bag 38.

Although the preferred embodiments of the present invention have been described above, the above configuration can, for example, be changed as follows.

Furthermore, the propulsion devices 13 and 101 of the embodiments above include battery packs 30 and 102, an electric motor 93 (hydraulic pump 103) and a screw 94 (crawler 104). The electric motor 93 (hydraulic pump 103) is driven by the electric power supplied from the battery packs 30 and 102. The screw 94 (crawler 104) uses the drive force generated by the electric motor 93 (hydraulic pump 103) to generate a propulsive force that moves the moving body (electric sliding body 1, all-terrain vehicle 100).

Consequently, it is possible to realize propulsion devices 13 and 101 having a configuration in which the temperature of the plurality of tubular batteries 34 is made uniform even in a wide operating temperature environment.

In the embodiments described above, although a plurality of holders 33 are arranged along the axial direction, the number of holders 33 may be one, and the holders 33 may also be arranged along another direction. Furthermore, in the present embodiment, although a single storage bag 38 accommodates a plurality of holders 33, a configuration which includes a plurality of storage bags 38 is also possible. In this case, for example, a configuration may be used in which a storage bag 38 is provided for each holder 33.

The battery pack 30 of the embodiments above can also be used for supplying electric power to vehicles other than the electric sliding body 1 and the all-terrain vehicle 100. Moreover, the battery pack 30 can also be used for supplying power to objects other than vehicles.

### DESCRIPTION OF REFERENCE NUMERALS

13, 101 Propulsion device
30, 102 Battery pack
31 Battery casing
32 External terminal
33 Holder
34 Tubular battery (battery)
35 Conductive plate
36 Closed part
37 Board housing unit
37a Battery control board (battery control unit)
38 Storage bag
41 Case body
42 Lid portion
42a Handle
42b Discharge valve (discharge unit)

1. A battery pack including:
a plurality of batteries;
a plurality of holders which hold the plurality of batteries;
a storage bag which is a flexible bag-shaped member that accommodates the holders holding the plurality of batteries, and is filled with an insulating filler that is fluid and not solidified during use; and
a battery casing that accommodates the storage bag in which the holders are accommodated.

2. The battery pack according to claim 1, including
a discharge part that opens when a gas is generated from the batteries, and at least discharges the gas to the outside of the battery casing.

3. The battery pack according to claim 2, wherein
the battery casing includes
a case body which has a cylindrical shape and has at least one end which is open, and
a lid portion that closes the portion of the case body which is open, and
a space filled by the insulating filler is closed by the lid portion, and the discharge part is formed in the lid portion.

4. The battery pack according to claim 1, including
a battery control unit that determines a state of the plurality of batteries based on a detection result of a sensor, wherein
the battery control unit is accommodated in the storage bag.

5. A propulsion device including:
the battery pack according to claim 1;
a drive source which is driven by electric power supplied from the battery pack; and
a propulsion unit that uses a drive force generated by the drive source to generate a propulsive force that moves a moving body.
